(19) United States
(12) Patent Application Publication
(10) Pub. No.: US 2013/0120538 A1
(43) Pub. Date: May 16, 2013

(54) STEREO CAMERA MODULE

(71) Applicants: Sun Mi Shin, Gyeonggi-do (KR); Joo Hyun Kim, Gyeonggi-do (KR); Soon Seok Kang, Gyeonggi-do (KR)

(72) Inventors: Sun Mi Shin, Gyeonggi-do (KR); Joo Hyun Kim, Gyeonggi-do (KR); Soon Seok Kang, Gyeonggi-do (KR)

(21) Appl. No.: 13/402,809

(22) Filed: Feb. 22, 2012

(30) Foreign Application Priority Data
Nov. 10, 2011 (KR) 10-2011-0117019

(51) Int. Cl. H04N 13/02

(52) U.S. Cl. 348/47; 348/E13.074

(57) ABSTRACT

Disclosed herein is a stereo camera module. The stereo camera module according to an exemplary embodiment of the present invention includes a sensor unit having heterogeneous sensors having different number of pixels and a lens unit adjusting an angle of view of the sensor unit.

### CROSS REFERENCE(S) TO RELATED APPLICATIONS

This application claims the benefit under 35 U.S.C. Section 119 of Korean Patent Application Serial No. 10-2011-0117019, entitled “Stereo Camera Module” filed on Nov. 10, 2011, which is hereby incorporated by reference in its entirety into this application.

### BACKGROUND OF THE INVENTION

1. Technical Field

The present invention relates to a stereo camera module, and more particularly, to a stereo camera module capable of improving a three-dimensional image effect and reducing the fatigue of the eye.

2. Description of the Related Art

Generally, a stereo camera implements a three-dimensional image by using two same sensors and a difference in a point of view occurring due to a position difference between the sensors. As the difference in a point of view between the sensors is increased, the three-dimensional image effect is increased, but the fatigue of the eye watching an image is increased. When considering the three-dimensional image effect, the fatigue of the eye, or the like, it is possible to more easily manufacture a stereo camera including homogeneous sensors having the same number of pixels, which results in the increase in the manufacturing costs of the stereo camera, as compared with manufacturing the stereo camera using a single sensor.

### RELATED ART DOCUMENT

### Patent Document

(Patent Document 1) 1. Japanese Laid-Open Patent No.: JP2006-093859

(Patent Document 2) 2. Korean Laid-Open Patent No.: KR2008-0073073

### SUMMARY OF THE INVENTION

An object of the present invention is to provide a stereo camera module capable of improving a three-dimensional image effect.

Another object of the present invention is to provide a stereo camera module capable of reducing manufacturing costs.

Another object of the present invention is to provide a stereo camera module capable of reducing a hardware size.

According to an embodiment of the present invention, there is provided a stereo camera module, including: a sensor unit having heterogeneous sensors having different number of pixels; and a lens unit adjusting an angle of view of the sensor unit.

The sensor unit may include a first sensor and a second sensor having a relatively smaller number of pixels than the first sensor, and the lens unit may include: a narrow angle lens reducing an angle of view for the first sensor; and a wide angle lens increasing an angle of view for the second lens.

The stereo camera module may further include a lens distortion compensation unit compensating for lens distortion of the lens unit, wherein the lens distortion compensation unit includes a line buffer memory in which a weight lookup table (LUT) necessary for lens distortion compensation is stored and reads the weight LUT stored in the line buffer memory in real time.

The stereo camera module may further include a scale adjustment unit adjusting a scale of an input image between the heterogeneous sensors, wherein the scale adjustment unit includes a line buffer memory in which a weight look up table (LUT) necessary for the scale adjustment between the heterogeneous sensors is stored and reads the weight LUT stored in the line buffer memory in real time.

The stereo camera module may further include a pan and tilt adjustment unit adjusting pan and tilt errors of the heterogeneous sensors, wherein the pan and tilt adjustment unit includes a line buffer memory in which parameters necessary for a new coordinate calculation are stored and reads the parameters stored in the line buffer memory in real time.

### BRIEF DESCRIPTION OF THE DRAWINGS

FIG. 1 is a block diagram showing a stereo camera module according to an exemplary embodiment of the present invention.

FIG. 2 is a diagram for describing X, Y, and Z axes in which errors of a binocular three-dimensional image camera occur.

FIG. 3 is a diagram for describing pan and tilt errors of the stereo camera module according to the exemplary embodiment of the present invention.

FIG. 4 is a flow chart showing a process of correcting lens distortion of a lens distortion compensation unit according to the exemplary embodiment of the present invention.

FIG. 5 is a flow chart showing a process of correcting a scale of a scale correction unit according to the exemplary embodiment of the present invention.

FIG. 6 is a flow chart showing a process of correcting pan and tilt of a pan and tilt adjustment unit according to the exemplary embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. Rather, these embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a stereo camera module according to an exemplary embodiment of the present invention will be described with reference to the accompanying drawings.

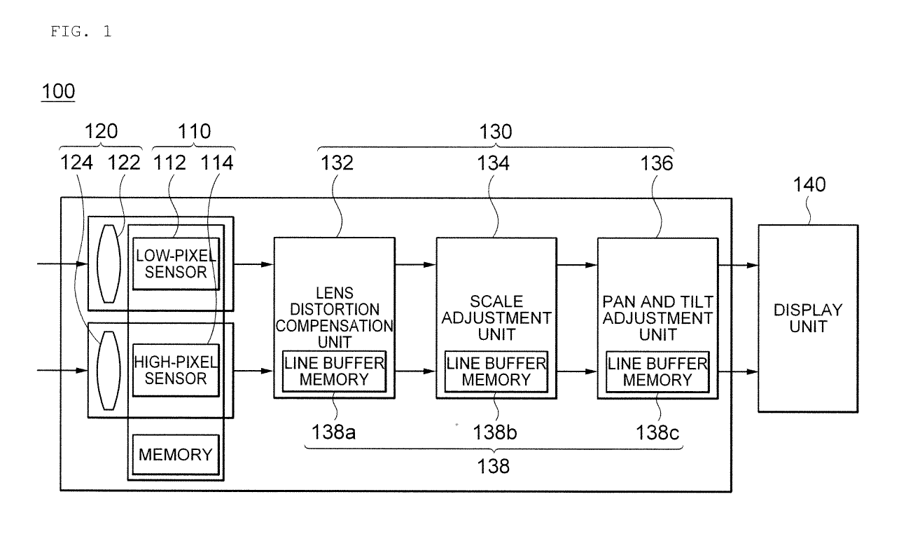

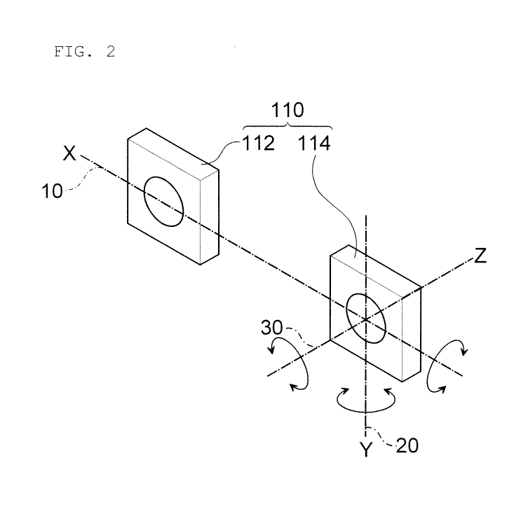

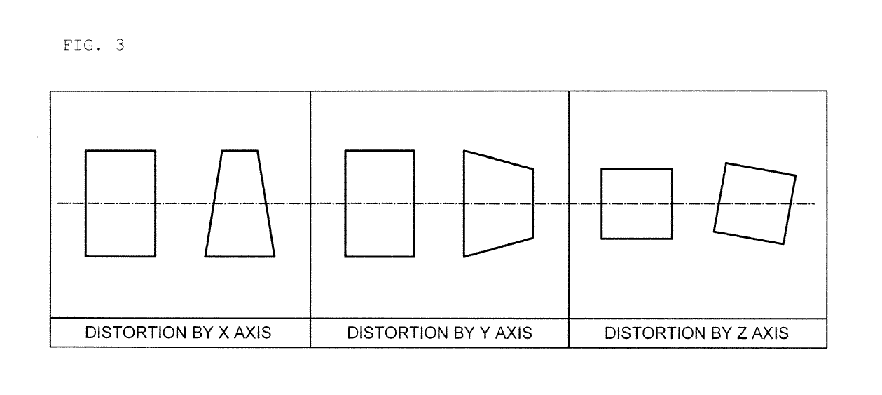

FIG. 1 is a block diagram showing a stereo camera module according to an exemplary embodiment of the present invention. FIG. 2 is a diagram for describing X, Y, and Z axes in which a binocular three-dimensional image camera occur and FIG. 3 is a diagram for describing pan and tilt errors of the stereo camera module according to the exemplary embodiment of the present invention.

Referring to FIG. 1, a stereo camera module 100 according to the exemplary embodiment of the present invention may include a sensor unit 110, a lens unit 120, and a correction unit 130.

The sensor unit 110 may include a plurality of sensor having different number of pixels. As an example, the sensor unit 110 may include a first sensor 112 and a second sensor 114 having a relatively smaller number of pixels than the first sensor 112. That is, the first sensor 112 may include a low-pixel sensor and the second sensor 114 may include a high-pixel sensor.

The lens unit 120 may adjust an angle of view of the sensor unit 110. For example, the lens unit 120 may include a first lens 122 that is disposed on a front surface of the first sensor 112 and a second lens 124 that is disposed on a front surface of the second sensor 114. The first lens 122 may reduce the angle of view for the first sensor 112 and the second lens 124 may increase the angle of view for the second sensor 114. That is, the first lens 122 may include a narrow angle lens and the second sensor 124 may include a wide angle lens. Therefore, when the lenses used in the first and second lenses 112 and 114 are 60°, the first lens 122 is provided to narrow the angle of view by being changed to approximately 55° and the second lens 124 is provided to widen approximately 80° so that each of the angles of view of the first and second sensors 112 and 114 are the same and similar as and to each other, thereby adjusting the angle of view.

As described above, when the heterogeneous sensors are not used and when the homogenous lenses are used, the angle of view needs to be adjusted, based on the image having the narrow angle of view. In this case, the high-pixel image out of the angle of view of the relatively low pixel is lost and therefore, a scaler logic is needed so as to meet a scale. To this end, the frame memory is provided, but a frame memory and scaler logic using the frame memory may increase a hardware size, which may increase the manufacturing costs thereof. Therefore, as described above, the sensor unit 110 including the heterogeneous sensors may reduce the hardware size and reduce the manufacturing costs, as compared with the case of using the homogeneous sensors.

The correction unit 130 may correct the lens distortion, scale difference, pan and tilt errors, or the like, that are generated at the time of using the first and second sensors 112 and 114 having different pixels of number. To this end, the correction unit 130 may include a lens distortion compensation unit 132, a scale adjustment unit 134, and a pan and tilt adjustment unit 136. The lens distortion compensation unit 132 may compensate for the lens distortion due to the first and second lenses 122 and 124 having different pixels of number. The scale adjustment unit 134 may correct the scale difference between the first and second sensors 112 and 114. Further, the pan and tilt adjustment unit 136 moves the image input from the first and second sensors 112 and 114 to new coordinates, thereby reducing the errors between the first and second sensors 112 and 114.

Next, the pan and tilt adjustment unit 136 will be described with reference to FIGS. 2 and 3. The binocular stereo camera combines the image signal of the first and second sensors 112 and 114 at a predetermined distance from each other in an X axis 10, thereby implement the three-dimensional image. In this case, when the first and second sensors 112 and 114 are distorted from each other based on 3 axes (X, Y, and Z axes), the visibility of the generated three-dimensional image may be reduced.

The tilt error occurs by the rotation of the X axis 10. When the tilt error occurs, as shown in FIG. 3, the phenomenon that the lengths in the top and bottom of the image photographed at the same height are differently photographed may occur.

The pan error occurs by the rotation of a Y axis 20. When the pan error occurs, as shown in FIG. 3, the lengths in the left and right portions of the image photographed at the same position may be differently photographed.

In addition, the rotation error occurs by the rotation of a Z axis and the horizon of the photographed image may be differently photographed.

As described above, when the sensors of the binocular camera module distort from each other based on three axes (X, Y, and Z axes), the difference in images photographed by each of the first and second sensors 112 and 114 occur at the time of photographing the image and thus, the distortion may occur in the three-dimensional image. The pan and tilt adjustment unit 136 may correct the aforementioned tilt error and pan error.

Meanwhile, in order to apply the aforementioned correction unit 130, parameters necessary for each component 132, 134 and 136 may be required. Therefore, a work to extract the parameters may be added. After the manufacturing of the stereo camera module 100 is completed, the stereo camera module 100 may extract the parameters by applying a plurality of images photographing the specific pattern image to a predetermined algorithm. An example of the algorithm may include “Comparison of stereo Matching algorithms for Mobile Robots” algorithm of Annika Kuhl, “Flexible New Technique for Camera Calibration” algorithm of ZhengyouZhang, or the like.

The extracted parameters as described above may be each stored in the memory 138 included in the correction unit 130. The memory 138 may include a first line buffer memory 138a, a second line buffer memory 138b, and a third line buffer memory 138c. The first line buffer memory 138a transfers the parameters extracted and stored as described above to the lens distortion compensation unit 132 so that the lens distortion compensation unit 132 may perform the lens distortion compensation. The second line buffer memory 138b transfers the parameter extracted and stored as described above to the scale adjustment unit 134 so that the scale adjustment unit 134 may adjust the scale. Further, the third line buffer memory 138c transfers the parameter extracted and stored as described above to the pan and tilt adjustment unit 136 so that the pan and tilt adjustment unit 136 may adjust the pan and tilt compensation.

As described above, the stereo camera module 100 according to the exemplary embodiment of the present invention corrects the image data photographed by each of the first and second sensors 112 and 114 having different number of pixels by the correction unit 130, thereby displaying the three-dimensional image to the outside through the predetermined display unit 140. As the display unit 140, the three-dimensional image display device may be used. Therefore, the exemplary embodiments of the present invention can display the three-dimensional image by photographing the image using heterogeneous sensors having the different number of pixels and then, correcting lens distortion, scale, and pan tilt on the image data.

In addition, the stereo camera module 100 according to the exemplary embodiment of the present invention may include the line buffer memory 138 to calculate the parameter values for correcting the lens distortion, the scale, and the pan and tilt in real time. Therefore, the camera module according to the exemplary embodiment can calculate parameters in real time by using only a buffer line memory, thereby reducing the hardware size and the manufacturing costs, as compared with the case including the frame memory.

Next, the correction process by the correction unit 130 of the stereo camera module 100 according to the exemplary embodiment of the present invention will be described in detail. Herein, the repeated contents of the aforementioned correction unit or the correction to be described below may be omitted or simplified.

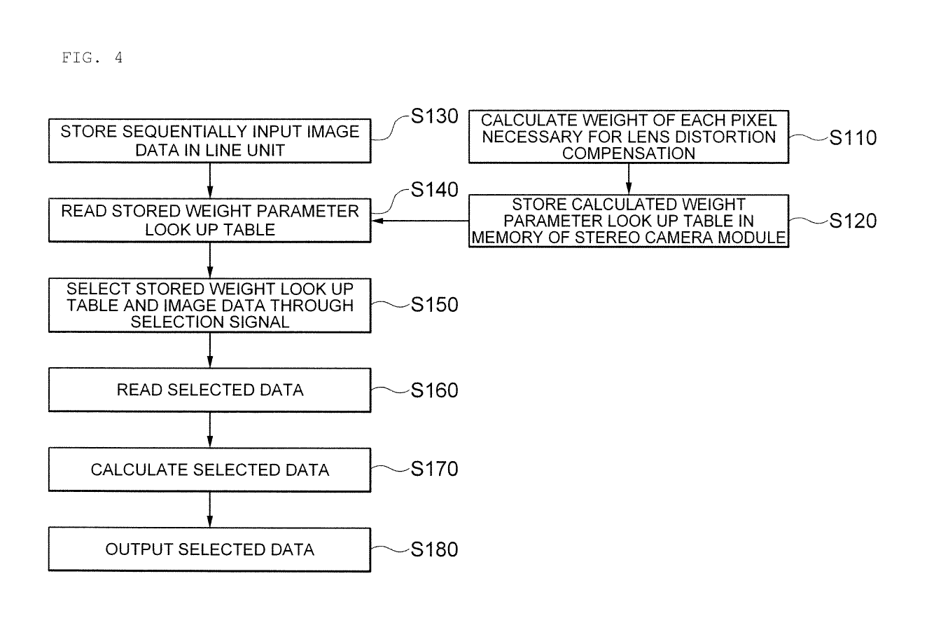

FIG. 4 is a flow chart showing a process of correcting lens distortion of a lens distortion compensation unit according to the exemplary embodiment of the present invention. Referring to FIGS. 1 and 4, a weight of each pixel necessary for the lens distortion compensation may be calculated (S110). Input factors of the lens distortion compensation unit 132 may be the distortion correction parameters and the image signal input to the first and second sensors 112 and 114. The lens distortion correction parameters may be calculated by the predetermined algorithm. An example of the algorithm may include “Comparison of stereo Matching algorithms for Mobile Robots” algorithm of Annika Kuhl, “Flexible New Technique for Camera Calibration” algorithm of ZhengyouZhang, or the like. A calculated weight parameter look up table (LUT) may be stored in the memory 138 of the stereo camera module 100 (S120). As an example, the results calculated as described above may be stored in the first line buffer memory 138a of the camera module. A process of storing the calculation results in the memory of the camera module may be separately performed after the manufacturing of the stereo camera module 100 is completed.

Meanwhile, the sequentially input image data are stored in a line unit (S130) and the stored weight parameter LUT may be read (S140) The reading of the LUT may be performed by reading the calculation results stored in the camera module memory 116. Further, the stored weight LUT and image data may each be selected through the predetermined selection signal (S150). In order to select the stored weight LUT and image data, the internal control signal may be generated. The selected data such as the parameter value to be applied to each pixel of the image and the pixel signal necessary for calculation, or the like, may be read through the generated signal (S160).

The data as described above may be calculated by using the predetermined algorithm (S170). As an example, the calculation of the read signals values may be calculated through a barrel distortion correction algorithm. In this case, since the image signal is stored in a line unit, the lens distortion correction as described above may be performed in real time. Next, the data selected as described above may be output (S180).

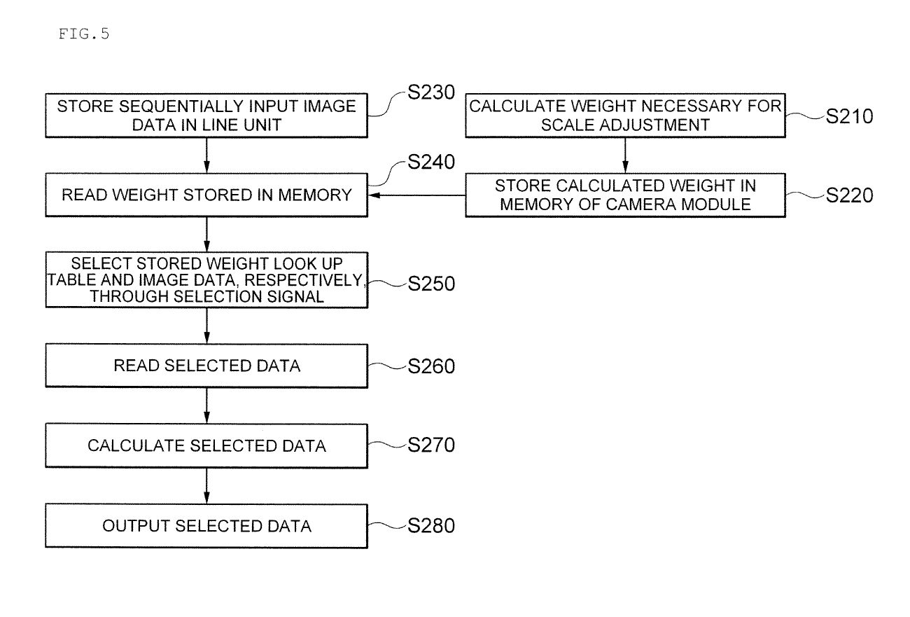

FIG. 5 is a flow chart showing a process of correcting a scale of a scale correction unit according to the exemplary embodiment of the present invention. Referring to FIGS. 1 and 5, the weight necessary for scale adjustment is calculated (S210) and the calculated weight may be stored in the memory 138 of the camera module (S220). As the input, the scale weight and the image signal input to the first and second sensors 112 and 114 may be required. The scale weights of the first and second sensors 112 and 114 may be determined through a parameter extraction algorithm. The determined scale weight may be stored in the memory 138 of the camera module. As an example, the memory 138 of the camera module may be the second line buffer memory 138b corresponding to the scale adjustment unit 134. A process of storing the calculation results in the memory of the camera module may be separately per formed after the manufacturing of the stereo camera module 100 is completed.

Meanwhile, the sequentially input image data are stored in a line unit (S230) and the weight stored in the memory 138 may be read (S240). The stored weight and image data are selected through the predetermined selection signal (S250) and the selected data may be read(S260). Further, after the selected data are calculated (S270), the selected data may be output (S280). Here, the image signal to which the weight is applied is stored in the line unit and may be read according to the control signal. In addition, the real-time operation may be performed by only the second line buffer memory 138b without using the frame memory.

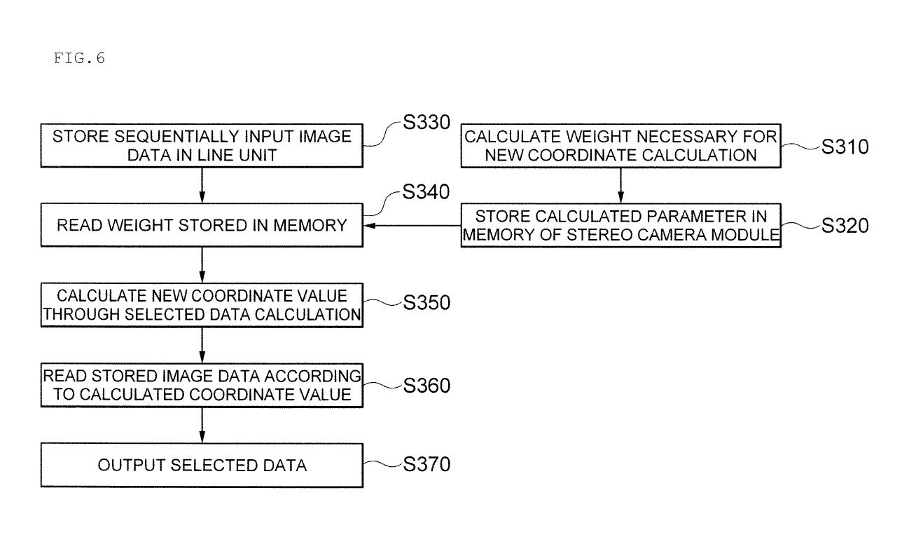

FIG. 6 is a flow chart showing a process of correcting pan and tilt of a pan and tilt adjustment unit according to the exemplary embodiment of the present invention. Referring to FIGS. 1 and 6, after the parameter necessary for new coordinate calculation is calculated (S310), the calculated parameter may be stored in the memory 130 of the stereo camera module (S320). Here, the memory 130 of the camera module may be the third line buffer memory 138c corresponding to the pan and tilt adjustment unit 136. A process of storing the calculation results in the memory of the camera module may be separately performed after the manufacturing of the stereo camera module 100 is completed.

Further, the image data sequentially input to the first and second sensors 112 and 114 maybe stored in the line unit (S330) and the parameter stored in the memory 138 may be read (S340). Meanwhile, the pan and tilt adjustment unit 136 moves the image input to each of the first and second sensors 112 and 114 to new coordinates, thereby reducing the errors between the first and second sensors 112 and 114. For example, the parameter values for calculating the new coordinates maybe needed. As the example, the parameter values may be calculated so as to calculate the new coordinates using the ZhengyouZhang algorithm.

The new coordinate values may be calculated through the selected data calculation as described above (S350). The stored image data may be read according to the calculated coordinate values (S350) and the selected data may be output (S360). Here, the read of the stored image data corresponds to reading the image signal stored in the line unit according to the calculated coordinates and therefore, the new coordination calculation may be processed in real time. In addition, the real-time calculation may be performed by applying the memory stored in the line unit.

As described above, the pan and tilt adjustment unit 136, which is a circuit adjusting each image in all directions according to the input parameters, adjusts the positions of the two input images, thereby generating the input image increasing the quality of image of the three-dimensional image.

As set forth above, the exemplary embodiments of the present invention can display the three-dimensional image by photographing the image using heterogeneous sensors having different number of pixels and then, correcting lens distortion, scale, and pan and tilt on the image data.

The camera module according to the exemplary embodiment can calculate parameters in real time by using only a buffer line memory, thereby reducing the hardware size and the manufacturing costs, as compared with the case including the frame memory.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A stereo camera module, comprising:
a sensor unit having heterogeneous sensors having different number of pixels; and
a lens unit adjusting an angle of view of the sensor unit.

2. The stereo camera module according to claim 1, wherein the sensor unit includes a first sensor and a second sensor having a relatively smaller number of pixels than the first sensor, and the lens unit includes:
a narrow angle lens reducing an angle of view for the first sensor; and
a wide angle lens increasing an angle of view for the second lens.

3. The stereo camera module according to claim 1, further comprising a lens distortion compensation unit compensating for lens distortion of the lens unit,
wherein the lens distortion compensation unit includes a line buffer memory in which a weight lookup table (LUT) necessary for lens distortion compensation is stored and reads the weight LUT stored in the line buffer memory in real time.

4. The stereo camera module according to claim 1, further comprising a scale adjustment unit adjusting a scale of an input image between the heterogeneous sensors,
wherein the scale adjustment unit includes a line buffer memory in which a weight lookup table (LUT) necessary for the scale adjustment between the heterogeneous sensors is stored and reads the weight LUT stored in the line buffer memory in real time.

5. The stereo camera module according to claim 1, further comprising a pan and tilt adjustment unit adjusting pan and tilt errors of the heterogeneous sensors,
wherein the pan and tilt adjustment unit includes a line buffer memory in which parameters necessary for a new coordinate calculation are stored and reads the parameters stored in the line buffer memory in real time.
